(19) United States
(12) Patent Application Publication
(10) Pub. No.: US 2019/0021090 A1
(43) Pub. Date: Jan. 17, 2019

(54) ELECTRONIC DEVICE AND OPERATION METHOD FOR ELECTRONIC DEVICE

(71) Applicant: SAMSUNG ELECTRONICS CO., LTD., Suwon-si, Gyeonggi-do (KR)

(72) Inventor: Heung-lok DO, Hwaseong-si, Gyeonggi-do (KR)

(73) Assignee: Samsung Electronics Co., Ltd., Suwon-si, Gyeonggi-do (KR)

(21) Appl. No.: 16/068,450

(22) PCT Filed: Dec. 22, 2016
(86) PCT No.: PCT/KR2016/015082

§ 371 Date: Jul. 6, 2018

(30) Foreign Application Priority Data
Jan. 8, 2016 (KR) 10-2016-0002781

(51) Int. Cl. H04W 72/04; H04W 36/06

(52) U.S. Cl. CPC H04W 72/0453; H04W 72/082; H04W 36/06

(57) ABSTRACT

Provided are an electronic device and a method of operating the electronic device. The electronic device includes a communicator; a memory storing one or more instructions that are executed by a processor; and a processor configured to execute the one or more instructions stored in the memory, wherein the processor executes the one or more instructions to: detect connection of a new wireless communication device; obtain information about a frequency band which is used by the new wireless communication device; and allocate, to the new wireless communication device and a previously-connected wireless communication device, respectively, frequency bands capable of not causing frequency interference therebetween in consideration of the information about the frequency band used by the new wireless communication device and information about a frequency band used by the previously-connected wireless communication device.

### TECHNICAL FIELD

The present disclosure relates to an electronic device and a method of operating the electronic device, and more particularly, to an electronic device capable of communicating with at least one wireless communication device, and a method of operating the electronic device.

### BACKGROUND ART

Recently, televisions (TVs) not only simply receive a broadcasting signal and show a broadcasting program on their screens, but also expand large screens included therein and an audio function via communication with various wireless communication devices.

For example, modern TVs can access the Internet, receive data from the Internet, and display the received data by communicating with a wireless router. In addition, modern TVs can reproduce and output audio data to a wireless headphone or a wireless audio device by communicating with the wireless headphone or the wireless audio device, thereby enabling a user to enjoy the audio data provided by the TV via the wireless headphone or the wireless audio device. Moreover, modern TVs can receive a still image or moving picture file stored in a camera from the camera by communicating with the camera. Also, modern TVs can receive content from a smartphone and reproduce the received content by communicating with the smartphone, or can transmit content to a smartphone such that the smartphone may reproduce the content.

Such TVs that perform a general audio visual data reproducing function at home are able to communicate with more wireless communication devices, due to the development and application of recent IoT technology.

However, a wireless frequency band in which various wireless communication devices and a TV perform communication is limited. A frequency band means a frequency range allocated to services of communication and broadcasting when the communication and the broadcasting operate by using radio waves. When the same frequency band is used for the services at the same time and in the same area, the services share the same path and are accordingly mixed.

Accordingly, as the number of wireless communication devices connecting to a TV increases, respective frequency bands in which the TV communicates with the wireless communication devices overlap with each other, and thus frequency interference often occurs.

### DESCRIPTION OF EMBODIMENTS

### Technical Problem

Provided are an electronic device capable of minimizing frequency interference by flexibly allocating respective frequency bands in which the electronic device communicates with a plurality of wireless communication devices, and a method of operating the electronic device.

Solution to Problem

According to an aspect of the present disclosure, an electronic device includes a communicator; a memory storing one or more instructions that are executed by a processor; and a processor configured to execute the one or more instructions stored in the memory, wherein the processor executes the one or more instructions to: detect connection of a new wireless communication device; obtain information about a frequency band which is used by the new wireless communication device; and allocate, to the new wireless communication device and a previously-connected wireless communication device, respectively, frequency bands capable of not causing frequency interference therebetween in consideration of the information about the frequency band used by the new wireless communication device and information about a frequency band used by the previously-connected wireless communication device.

According to an embodiment, the processor may execute the one or more instructions to, when it is determined that the frequency band used by the new wireless communication device interferes with the frequency band used by the previously-connected wireless communication device, allocate another frequency band as a frequency band for the previously-connected wireless communication device.

According to an embodiment, the processor may execute the one or more instructions to, when it is determined that the frequency band used by the new wireless communication device interferes with the frequency band used by the previously-connected wireless communication device, output a user interface for indicating that the frequency band used by the new wireless communication device interferes with the frequency band used by the previously-connected wireless communication device.

According to an embodiment, the processor may execute the one or more instructions to, when it is determined that the frequency band used by the new wireless communication device interferes with the frequency band used by the previously-connected wireless communication device, output a user interface for guiding at least one of the new wireless communication device and the previously-connected wireless communication device to be disconnected from the electronic device.

According to an embodiment, the processor may execute the one or more instructions to receive, from the new wireless communication device, the information about the frequency band that is used by the new wireless communication device.

According to another aspect of the present disclosure, a method of operating an electronic device includes detecting connection of a new wireless communication device; obtaining information about a frequency band that is used by the new wireless communication device; and allocating, to the new wireless communication device and a previously-connected wireless communication device, respectively, frequency bands capable of not causing frequency interference therebetween in consideration of the information about the frequency band used by the new wireless communication device and information about a frequency band used by the previously-connected wireless communication device.

According to another aspect of the present disclosure, a computer program product includes one or more computer-readable storage media having recorded thereon a program, which, when executed by a computer, performs a method of operating an electronic device, the method comprising: detecting connection of a new wireless communication device; obtaining information about a frequency band that is used by the new wireless communication device; and allocating, to the new wireless communication device and a previously-connected wireless communication device, respectively, frequency bands capable of not causing frequency interference therebetween in consideration of the information about the frequency band used by the new wireless communication device and information about a frequency band used by the previously-connected wireless communication device

### Advantageous Effects of Disclosure

According to the present disclosure, an electronic device is able to minimize frequency interference by flexibly allocating respective frequency bands at which the electronic device communicates with a plurality of wireless communication devices.

### BRIEF DESCRIPTION OF DRAWINGS

FIG. 1 illustrates a network environment in which at least one wireless communication device is connected to an electronic device, according to an embodiment.

FIG. 2 is a schematic block diagram of devices in a network environment in which at least one wireless communication device is connected to an electronic device, according to an embodiment.

FIGS. 3A and 3B are block diagrams of a detailed configuration of the electronic device of FIG. 2.

FIG. 4 is a flowchart of operations performed in an electronic device according to an embodiment.

FIG. 5 is a diagram for explaining frequency bands that are used by two wireless communication devices.

FIGS. 6A and 6B are reference diagrams for explaining frequency band reallocation between a plurality of wireless communication devices in an electronic device, according to an embodiment.

FIG. 7 illustrates an example of a user interface (UI) that may be output during an operation of an electronic device, according to an embodiment.

FIG. 8 illustrates another example of a UI that may be output during an operation of an electronic device, according to an embodiment.

FIG. 9 illustrates another example of a UI that may be output during an operation of an electronic device, according to an embodiment.

FIG. 10 illustrates another example of a UI that may be output during an operation of an electronic device, according to an embodiment.

### MODE OF DISCLOSURE

Reference will now be made in detail to embodiments, examples of which are illustrated in the accompanying drawings. A method of constructing and using an electronic device, according to an embodiment of the present disclosure, will now also be described with reference to the accompanying drawings. Like reference numerals or characters in the drawings denote like parts or components.

While such terms as “first”, “second”, etc., may be used to describe various components, such components must not be limited to the above terms. The terms first and second should not be used to attach any order of importance but are used to distinguish one element from another element. For example, a first component discussed below could be termed a second component, and similarly, a second component may be termed a first component without departing from the teachings of this disclosure. The term “and/or” includes any and all combinations of one or more of the associated listed items.

The terms used in the present specification are merely used to describe particular embodiments, and are not intended to limit the present disclosure. An expression used in the singular encompasses the expression of the plural, unless it has a clearly different meaning in the context. In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

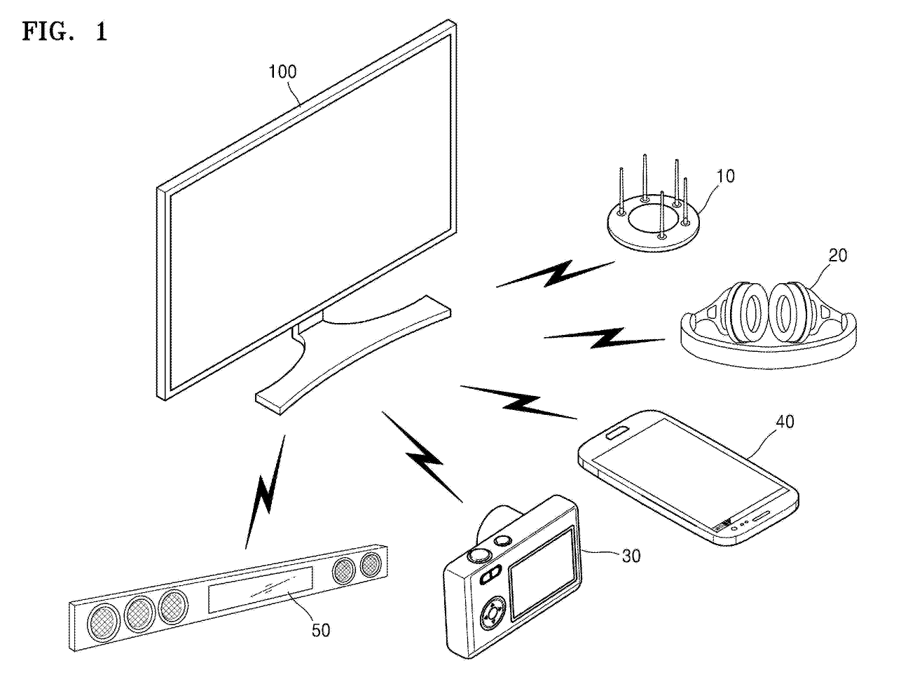

FIG. 1 illustrates a network environment in which at least one wireless communication device is connected to an electronic device according to an embodiment.

Referring to FIG. 1, the network environment includes an electronic device 100, a wireless router 10, a wireless headphone 20, a camera 30, a smartphone 40, and a wireless audio device 50.

In FIG. 1, the electronic device 100 is a display apparatus such as a TV. However, the electronic device 100 is not limited thereto, and, as described below, the electronic device 100 may be any electronic device as long as it functions as a master device including a processor and a communicator.

The wireless router 10 is a network device capable of connecting at least one wireless communication device to a high-speed Internet line, and is also referred to an access point (AP). The wireless router 10 may use a 2.4 GHz band and a 5 GHz band to accomplish WiFi communication.

The Bluetooth headphone 20 may communicate with the electronic device 100 via Bluetooth communication, and may receive audio output by the electronic device 100 via Bluetooth communication and output the received audio. Bluetooth communication uses a 2400 to 2483.5 MHz band.

The camera 30 may communicate with the electronic device 100 via Bluetooth communication, and may transmit a moving picture or a still image stored in the camera to the electronic device 100 via Bluetooth communication.

The smartphone 40 may communicate with the electronic device 100 via WiFi communication or Bluetooth communication, and may transmit content stored in the smartphone 40 to the electronic device 100 via WiFi or Bluetooth communication or receive content from the electronic device 100 via WiFi or Bluetooth communication.

The wireless audio device 50 may communicate with the electronic device 100 via Bluetooth communication or WiFi communication, and may receive audio output by the electronic device 100 and output the received audio.

As such, one or more wireless communication devices that communicate using various frequency bands may be connected to the electronic device 100. For example, when the electronic device 100 communicates with the wireless router 10 by using a 2.4 GHz band and, during the same time, the Bluetooth headphone 20 communicating using the same 2.4 GHz band is connected to the electronic device 100, frequency interference may occur between the communication of the electronic device 100 with the wireless router 10 and the communication of the electronic device 100 with the Bluetooth headphone 20.

Accordingly, according to an embodiment, when communication of a new wireless communication device is detected while the electronic device 100 is communicating with a previous wireless communication device, the electronic device 100 may re-allocate frequency bands between which interference may be avoided, in consideration of a frequency band used during the communication with the previous wireless communication device and a frequency band used during the communication with the new wireless communication device, thereby avoiding frequency interference.

A wireless device that communicates with the electronic device 100 of FIG. 1 is merely an example, and various wireless communication devices and Internet of Things (IoT) devices may communicate with the electronic device 100.

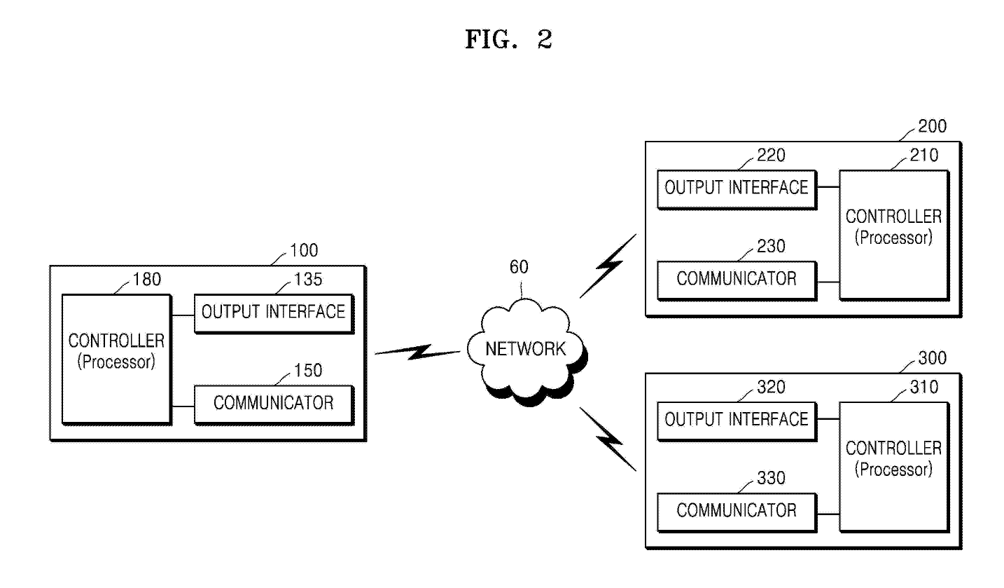

FIG. 2 is a schematic block diagram of devices in a network environment in which at least one wireless communication device is connected to an electronic device according to an embodiment.

Referring to FIG. 2, the network environment includes an electronic device 100, a first wireless communication device 200, and a second wireless communication device 300 connected to each other via a network 60.

The network 60 indicates any of various wireless communication networks, such as WiFi, Bluetooth, and Zigbee.

The electronic device 100 includes a controller 180, a communicator 150, and an output interface 135.

The communicator 150 of the electronic device 100 performs communication with the first wireless communication device 200 and the second wireless communication device 300 via the network 60.

The output interface 135 may output processed data from the controller 180 or the communicator 150.

The controller 180 includes at least one processor and controls operations of all components of the electronic device 100.

The first wireless communication device 200 includes a controller 210, an output interface 220, and a communicator 230.

The controller 210 includes at least one processor and controls operations of all components of the first wireless communication device 200.

The communicator 230 may communicate with the electronic device 100 via the network 60.

The output interface 220 may output data processed by the first wireless communication device 200.

Similarly, the second wireless communication device 300 includes a controller 310, an output interface 320, and a communicator 330.

The controller 310 includes at least one processor and controls operations of all components of the second wireless communication device 300.

The communicator 330 may communicate with the electronic device 100 via the network 60.

The output interface 320 may output data processed by the second wireless communication device 300.

According to an embodiment, an operation of the electronic device 100 in the network environment of FIG. 2 will now be described.

First, the communicator 150 of the electronic device 100 may communicate with the first wireless communication device 200 by using a first communication frequency band. As such, while the communicator 150 of the electronic device 100 and the first wireless communication device 200 are communicating with each other by using the first communication frequency band, the electronic device 100 may sense communication connection of the second wireless communication device 300.

According to an embodiment, the electronic device 100 may determine whether the second wireless communication device 300 uses a same or similar wireless frequency band as or to the first communication frequency band that may cause interference in the communication with the first wireless communication device 100, namely, uses the first communication frequency band.

According to an embodiment, when the electronic device 100 determines that the second wireless communication device 300 uses a same or similar wireless frequency band as or to the first communication frequency band that may interfere in the communication with the first wireless communication device 100, namely, uses the first communication frequency band, the electronic device 100 may newly allocate wireless frequency bands that are to be respectively used in the communication with the first wireless communication device 200 and the communication with the second wireless communication device 300.

According to an embodiment, if the electronic device 100 may use a frequency band other than the first communication frequency band during the communication with the first wireless communication device 200, the electronic device 100 may newly allocate the other frequency band during the communication with the first wireless communication device 200.

According to an embodiment, when the electronic device 100 determines that the frequency band used in the communication with the first wireless communication device 200 and the frequency band used in the communication with the second wireless communication device 300 interfere with each other, the electronic device 100 may output at least one user interface (UI) for informing a user of this determination.

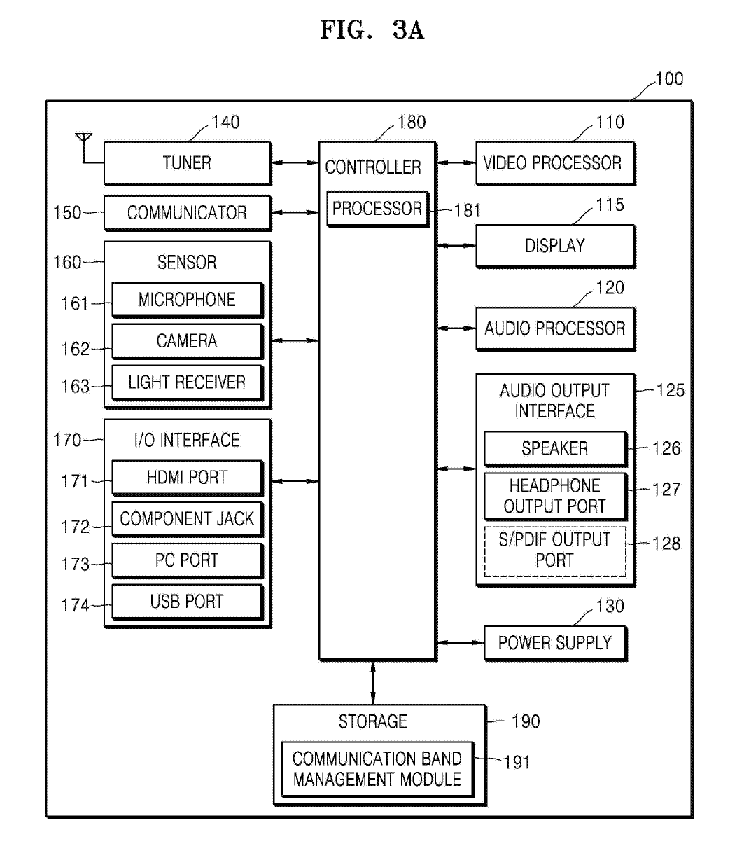

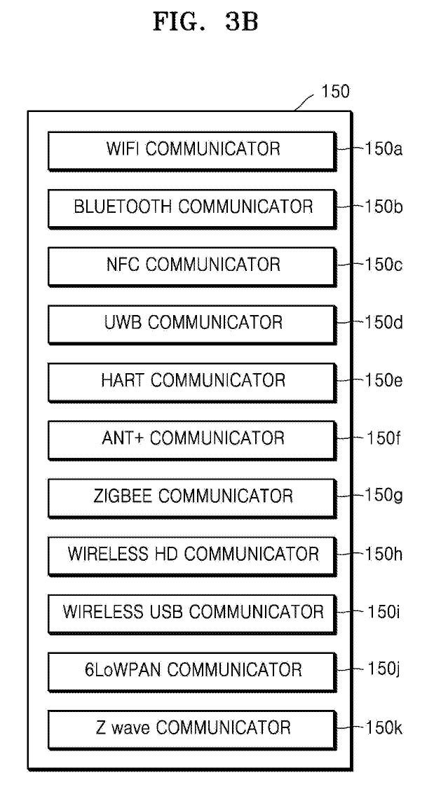

FIG. 3A is a block diagram of a detailed configuration of the electronic device 100 of FIG. 2.

Referring to FIG. 3A, the electronic device 100 includes a video processor 110, a display 115, an audio processor 120, an audio output interface 125, a power supply 130, a tuner 140, the communicator 150, a sensor 160, an input/output (I/O) interface 170, the controller 180, and a storage 190.

The video processor 110 processes video data that is received by the electronic device 100. The video processor 110 may perform a variety of image processing, such as decoding, scaling, noise filtering, frame rate transformation, and resolution transformation, on the received video data.

The display 115 displays video included in a broadcasting signal received via the tuner 140 on the screen thereof, under the control of the controller 180. The display 115 may also display content (for example, a moving picture) that is input via the communicator 150 or the I/O interface 170. The display 115 may output an image stored in the storage 190 under the control of the controller 180.

According to an embodiment, when it is determined that frequency bands used by the electronic device 100 to communicate with a plurality of communication devices interfere with each other, the display 115 may output a UI indicating that interference may occur between the frequency bands.

The audio processor 120 processes audio data. The audio processor 120 may perform a variety of processing, such as decoding, amplification, or noise filtering, on the audio data.

The audio output interface 125 may output audio included in a broadcasting signal received via the tuner 140, audio (for example, a voice or a sound) that is input via the communicator 150 or the I/O interface 170, and audio stored in the storage 190, under the control of the controller 180. The audio output interface 125 may include at least one selected from a speaker 126, a headphone output port 127, and a Sony/Philips Digital Interface (S/PDIF) output port 128.

The power supply 130 supplies power that is input from an external power source, to the internal components 110 through 190 of the electronic device 100, under the control of the controller 180.

The tuner 140 may tune and select only a frequency of a channel that the electronic device 100 wants to receive from among many radio wave components that are obtained by, for example, amplifying, mixing, or resonating a wired or wireless broadcasting signal. The broadcasting signal includes audio, video, and additional information (for example, an electronic program guide (EPG)).

The tuner 140 may receive a broadcasting signal in a frequency band corresponding to a channel number according to a user input (for example, a control signal received from a control device, for example, e.g., a channel number input, a channel up-down input, and a channel input on an EPG screen image).

The tuner 140 may receive a broadcasting signal from various sources, such as terrestrial broadcasting, cable broadcasting, satellite broadcasting, and Internet broadcasting. The tuner 140 may also receive a broadcasting signal from a source such as analog broadcasting or digital broadcasting. The broadcasting signal received via the tuner 140 is decoded (for example, audio decoding, video decoding, or additional information decoding) and is thus divided into audio, video, and/or additional information. The audio, the video, and/or the additional information may be stored in the storage 190 under the control of the controller 180.

The communicator 150 may connect the electronic device 100 to an external device (for example, an audio device) under the control of the controller 180. The controller 180 may transmit/receive content to/from the external device connected via the communicator 150, download an application from the external device, or perform web-browsing. The communicator 150 may include at least one communication module in correspondence to a performance and a structure of the electronic device 100.

According to an embodiment, the communicator 150 may perform communication with at least one communication device via at least one module by using at least one communicating method. The communicator 150 will be described in more detail with reference to FIG. 3B.

The sensor 160 senses a voice of a user, an image of the user, or an interaction with the user.

A microphone 161 receives an uttered voice of the user. The microphone 161 may transform the received voice into an electrical signal and output the electrical signal to the controller 180.

A camera 162 receives an image (for example, consecutive frames) corresponding to a motion of the user including a gesture within a camera recognition range. The camera 162 may convert a received image into an electrical signal under the control of the controller 180 and output the electrical signal to the controller 180.

The camera 162 may include a lens (not shown) and an image sensor (not shown). The camera 162 may support optical zoom or digital zoom by using a plurality of lenses and image processing.

A light receiver 163 receives an optical signal (including a control signal) from the external control device via a light window (not shown) located, for example, in or on the bezel of the display 115. The light receiver 163 may receive an optical signal corresponding to a user input (for example, touch, pressing, a touch gesture, a voice, or a motion) from the control device. A control signal may be extracted from the received optical signal under the control of the controller 180.

The I/O interface 170 receives video (for example, a moving picture), audio (for example, a voice or music), and additional information (for example, an EPG) from outside the electronic device 100 under the control of the controller 180. The I/O interface 170 may include a High-Definition Multimedia Interface (HDMI) port 171, a component jack 172, a personal computer (PC) port 173, or a universal serial bus (USB) port 174. The /O interface 170 may include a combination of the HDMI port 171, the component jack 172, the PC port 173, and the USB port 174.

It will be understood by one of ordinary skill in the art that the structure and operation of the I/O interface 170 may be variously implemented according to embodiments.

The controller 180 controls an overall operation of the electronic device 100 and a signal flow between the internal components 110 through 190 of the electronic device 100, and processes data. When there is an input of a user or preset and stored conditions are satisfied, the controller 180 may execute an operation system (OS) and various applications that are stored in the storage 180. A processor 181 may be implemented by using a System On Chip (SoC) into which a core and a GPU are incorporated. The processor 181 may include a plurality of processors.

According to an embodiment, by executing one or more instructions of a communication band management module 191 stored in the storage 190, the controller 180 may detect connection of a new wireless communication device, obtain information about a frequency band used by the new wireless communication device, and allocate, to the new wireless communication device and a previously-connected wireless communication device, frequency bands between which frequency interference may be avoided in consideration of the information about the frequency band used by the new wireless communication device and information about a frequency band used by the previously-connected wireless communication device.

According to an embodiment, by executing one or more instructions of the communication band management module 191 stored in the storage 190, when it is determined that the frequency band used by the new wireless communication device interferes with the frequency band used by the previously-connected wireless communication device, the controller 180 may re-allocate another frequency band as the frequency band of the previously-connected wireless communication device, in order to provide the frequency band used by the new wireless communication device.

According to an embodiment, by executing one or more instructions of the communication band management module 191 stored in the storage 190, when it is determined that the frequency band used by the new wireless communication device interferes with the frequency band used by the previously-connected wireless communication device, the controller 180 may output a UI for indicating that the frequency band used by the new wireless communication device may interfere with the frequency band used by the previously-connected wireless communication device.

According to an embodiment, by executing one or more instructions of the communication band management module 191 stored in the storage 190, when it is determined that the frequency band used by the new wireless communication device interferes with the frequency band used by the previously-connected wireless communication device, the controller 180 may output a UI for guiding at least one of the new wireless communication device and the previously-connected wireless communication device to be disconnected from the electronic device 100.

It will be easily understood by one of ordinary skill in the art that the structure and operation of the controller 180 may be variously implemented according embodiments.

The storage 190 may store various data, programs, or applications for driving and controlling the electronic device 100 under the control of the controller 180. The storage 190 may include random-access memory (RAM) that stores a signal or data input by an external source of the electronic device 100 or is used as a storage area for various operations performed by the electronic device 100, and read-only memory (ROM) that stores a control program for controlling the electronic device 100.

The storage 190 may include a memory card (e.g., a micro SD card or a USB memory) mounted in the electronic device 100, a non-volatile memory, a volatile memory, a hard disk drive (HDD), or a solid state drive (SSD), in addition to the RAM and the ROM.

The storage 190 may include a broadcasting receiving module, a channel control module, a volume control module, a communication control module, a voice recognition module, a motion recognition module, a light receiving module, a display control module, an audio control module, an external input control module, a power control module, a power control module of a wirelessly (for example, Bluetooth) connected external device, a voice database (DB), or a motion DB, which are not shown. The controller 180 may perform each function by using the software stored in the storage 190.

Each module includes instructions for performing various functions provided by the electronic device 100, and the functions of the modules may be intuitively inferred from the names of the modules by one of ordinary skill in the art.

According to an embodiment, the storage 190 may include the communication band management module 191 including one or more instructions to sense a connection of the new wireless communication device, obtain information about the frequency band used by the new wireless communication device, and allocate, to the new wireless communication device and the previously-connected wireless communication device, frequency bands between which frequency interference may be avoided in consideration of the information about the frequency band used by the new wireless communication device and the information about the frequency band used by the previously-connected wireless communication device.

The communication band management module 191 may further include one or more instructions to, when it is determined that the frequency band used by the new wireless communication device interferes with the frequency band used by the previously-connected wireless communication device, allocate another frequency band as the frequency band of the previously-connected wireless communication device in order to provide the frequency band used by the new wireless communication device.

The communication band management module 191 may further include one or more instructions to, when it is determined that the frequency band used by the new wireless communication device interferes with the frequency band used by the previously-connected wireless communication device, output a UI for indicating that the frequency band used by the new wireless communication device may interfere with the frequency band used by the previously-connected wireless communication device.

The communication band management module 191 may further include one or more instructions to, when it is determined that the frequency band used by the new wireless communication device interferes with the frequency band used by the previously-connected wireless communication device, output a UI for guiding at least one of the new wireless communication device and the previously-connected wireless communication device to be disconnected from the electronic device 100.

According to the performance of the electronic device 100, at least one component may be added to the components (for example, the components 110 through 190) of the electronic device 100 of FIG. 3B, or at least one of the components (for example, the components 110 through 190) of the electronic device 100 of FIG. 3B may be deleted. It will also be easily understood by one of ordinary skill in the art that the locations of the components (for example, the components 110 through 190) of the electronic device 100 may be changed according to the performance or structure of the electronic device 100.

FIG. 3B is a block diagram of a detailed configuration of the communicator 150 of FIG. 3A.

A WiFi communicator 150a performs WiFi communication, which is wireless technology defined by the IEEE802.11 standard. WiFi 802.11b uses a 2.4 GHz ISM band, and WiFi 802.11a uses a 5 GHZ band. A recent standard includes 802.11ac, and 802.11ac uses a 5 GHz ISM band. 802.11ad uses a 60 GHz band. The electronic device 100 may communicate with a smartphone, a laptop computer, a tablet PC, an Ultra book, a video accessory, a home wireless router, and the like by using the WiFi communicator 150a.

A Bluetooth communicator 150b operates in a 2.4 GHz ISM band. A frequency band is 2400 to 2483.5 MHz. A radio frequency (RF) channel is formed at intervals of 1 MHz. The electronic device 100 may communicate with a wireless headset, a laptop computer, a printer, a wireless speaker, a digital camera, a wireless keyboard & mouse, a video game player, and the like by using the Bluetooth communicator 150b.

Near-field communication (NFC) used in an NFC communicator 150c is an ultra-short range technology developed for stable payment trade. Many smartphones include NFC, and thus the electronic device 100 may communicate with smartphones by using the NFC communicator 150c. NFC uses a 13.56 MHz ISM frequency.

An ultra-wideband (UWB) communicator 150d uses a 3.1 to 10.6 GHz band, and provides high-speed data connectivity for PCs, laptop computers, set-top boxes, and other devices. This band is divided into a plurality of 528 MHZ wide channels. A UWB is used in video applications, such as a TV set, a camera, a laptop computer, and a video monitor.

An HART communicator 150e is wired networking technology for use in monitoring and controlling sensors and actuators, wherein HART is the abbreviation for a highway addressable remote transducer protocol. A wireless HART is a wireless version of this HART standard. A basic wireless HART is a 802.12.4 standard that operates in a 2.4 GHz band.

ANT+ used in an ANT+ communicator 150f is home-appliance wireless sensor networking technology used in collecting and transmitting sensor data. Major applications of ANT as a type of personal area network include sports, health, and home health. ANT may be used in, for example, a heart rate monitor, a speedometer, a calorimeter, a blood pressure monitor, a location tracker, and a thermostat. This technology uses a frequency band of 2.4 GHz.

A Zigbee communicator 150g uses a 2.4 GHz band. Zigbee communication implements not only from automated electrical measuring instrument to a smart meter for implementing a home area network connection, but also implements building automation for lighting and heating, ventilation, and air conditioning (HVAC) control.

A wireless HD communicator 150h is a high speed technology using a 60 GHz band. This standard was developed for consumer electronics, such as a wireless video display, an HDTV set, and a DVR or DVD player that usually use an interface, such as an HDMI or a display port.

A wireless USB communicator 150i uses a 3.1 to 10.6 GHz band. The electronic device 100 may usually communicate with a human interface device (HID), such as a keyboard, a mouse, and a game controller, by using the wireless USB communicator 150i.

A 6LoWPAN communicator 150j is for using an Internet protocol over a low-power wireless personal area network (LoWPAN) and a sensor network, and the electronic device 100 may communicate with, for example, a health monitoring device or an environment monitoring device, by using the 6LoWPAN communicator 150j.

A Z wave communicator 150k operates in a 1 GHz narrow band. The electronic device 100 may communicate with a home automation and lighting control apparatus, a thermostat, a smoke detector, a door lock, home appliances, and a security system by using the Z wave communicator 150k.

As such, the communicator 150 may have a plurality of detailed communication modules capable of performing communication using various communicating methods, and thus the electronic device 100 may simultaneously communicate with a plurality of wireless communication devices by using the plurality of detailed communication modules included in the communicator 150.

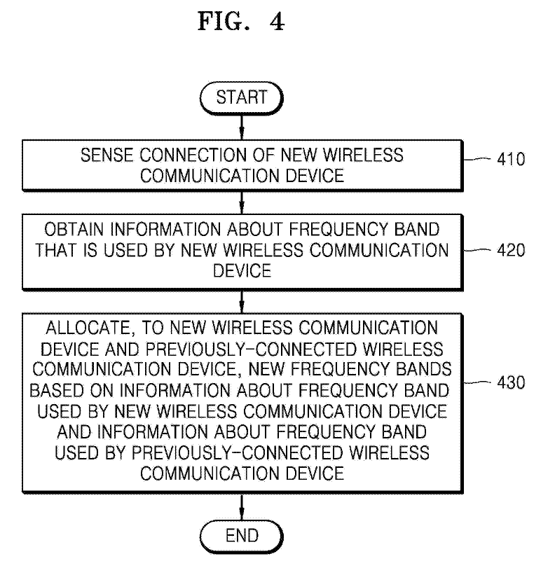

FIG. 4 is a flowchart of operations performed in an electronic device according to an embodiment.

Referring to FIG. 4, in operation 410, the electronic device 100 detects connection of a new wireless communication device.

In detail, when each communication module of the communicator 150 of the electronic device 100 of FIG. 3B receives a frame of a specific format recognizable by the communication module within a frequency band where the communication module operates and at a channel of the frequency band, an operation of the communication module may be performed. Accordingly, when each communication module receives a frame recognized thereby or when an operation of the communication module is performed, the electronic device 100 may detect connection of a new wireless communication device.

For example, a device desired to be discovered during WiFi communication (P2P device) may be in a listen state. A P2P device in a listen state stays at a given channel referred to as a listen channel, and the listen channel is a channel selected from a social channel list. During WiFi communication, channels 1, 6, and 11 are used as social channels within a 2.4 GHz band. The P2P device in a listen state may response to only a probe request frame formed in a specific format. Accordingly, a WiFi communicator of the electronic device 100 may respond to a communication device that has transmitted a frame of a specific format via WiFi communication, while standing by at a specific channel, namely, a listen channel, and thus, when this response is made, the electronic device 100 may sense connection of a new wireless communication device. Moreover, according to an initial process including the above-described response, the electronic device 100 may not only sense connection of a new wireless communication device but also may identify frequency band information of communication that the new wireless communication device is to perform.

In operation 420, the electronic device 100 obtains information about a frequency band that is used by the new wireless communication device.

Because each communication module of the communicator 150 of the electronic device 100 operates in a corresponding frequency band and a corresponding channel, the controller 180 of the electronic device 100 may identify the information about the frequency band that is used by the new wireless communication device, by checking a communication module that started operating.

For example, when a Bluetooth module of the communicator 150 of the electronic device 100 has started its operation, the controller 180 may obtain a 2.4 GHz ISM, which is a frequency band for use in Bluetooth communication, as the frequency band information that is used by the new wireless communication device.

In another example, the electronic device 100 may receive, from the new wireless communication device, a signal including information about a frequency band or a channel that is used by the new wireless communication device.

In operation 430, the electronic device 100 allocates, to the new wireless communication device and a previously-connected wireless communication device, frequency bands between which frequency interference may be avoided based on the information about the frequency band used by the new wireless communication device and information about the frequency band used by the previously-connected wireless communication device.

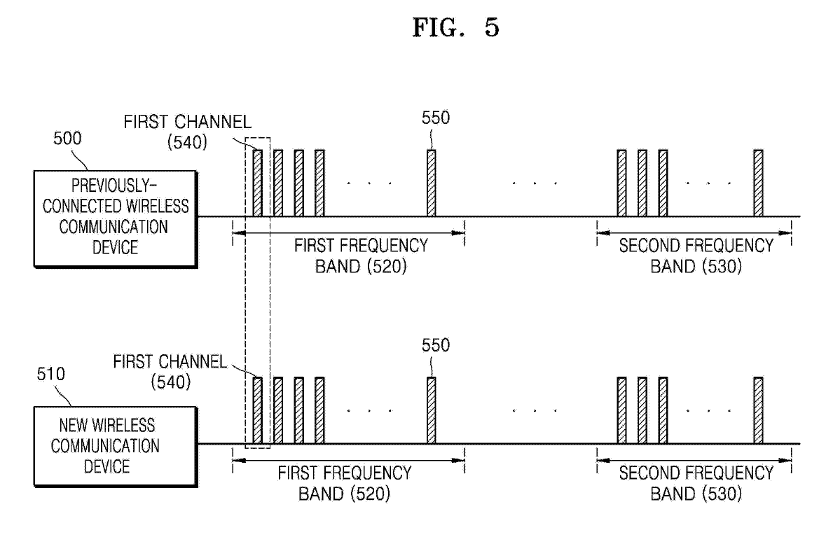

A detailed description of the operation 430 will now be given with reference to FIG. 5.

The controller 180 of the electronic device 100 may determine whether a frequency band used by a new wireless communication device 510 interferes with a frequency band used by a previously-connected wireless communication device 500, based on information about the frequency band used by the new wireless communication device 510 and information about the frequency band used by the previously-connected wireless communication device 500. For example, when the previously-connected wireless communication device 500 uses a first frequency band 520 and the new wireless communication device 510 also uses the first frequency band 520, the controller 180 may determine that frequency interference has occurred therebetween. For example, when the previously-connected wireless communication device 500 uses a first channel 540 of the first frequency band 520 and the new wireless communication device 510 also uses the first channel 540 of the first frequency band 520, the controller 180 may determine that frequency interference has occurred therebetween.

When the controller 180 of the electronic device 100 determines that frequency interference has occurred between a frequency band used by a new wireless communication device and a frequency band used by a previously-connected wireless communication device as described above, the controller 180 may allocate frequency bands between which frequency interference may be avoided, to the new wireless communication device and the previously-connected wireless communication device.

According to various embodiments, the electronic device 100 may allocate frequency bands to avoid frequency interference.

According to an embodiment, when the new wireless communication device 510 is able to use another frequency band, for example, a second frequency band 530, the controller 180 may allocate the second frequency band 530 to the new wireless communication device 510. To this end, the controller 180 may transmit to the new wireless communication device 510 a control signal that enables the communicator 150 to use the other frequency band. When the new wireless communication device 510 is able to use another frequency channel within the same frequency band, the controller 180 may allocate another frequency channel within the same frequency band, namely, a second channel 550 within the first frequency band 520, to the new wireless communication device 510.

According to an embodiment, when the previously-connected wireless communication device 500 is able to use another frequency band, for example, the second frequency band 530 other than the first frequency band 520, which is a currently-being-used frequency band, the controller 180 may allocate the second frequency band 530 to the previously-connected wireless communication device 500. Similarly, when the previously-connected wireless communication device 500 is able to use another frequency channel within the same frequency band, the controller 180 may allocate another frequency channel within the same frequency band, namely, the second channel 550 other than the previously-used first channel within the first frequency band 520, to the previously-connected wireless communication device 500.

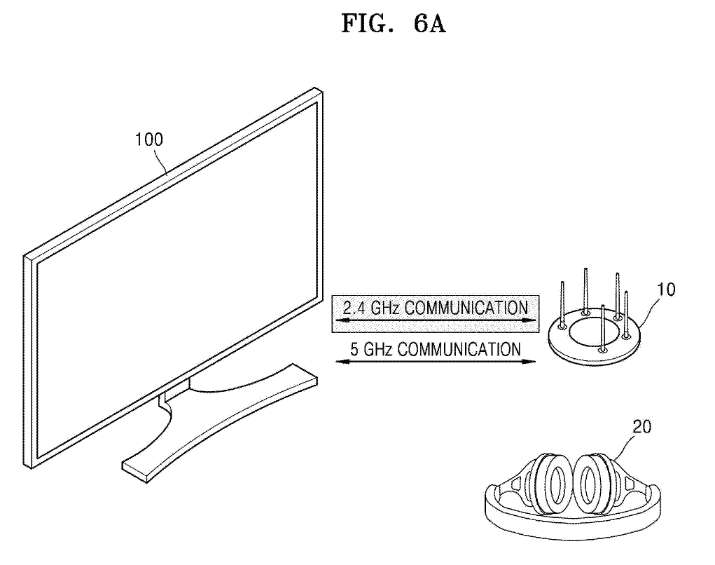

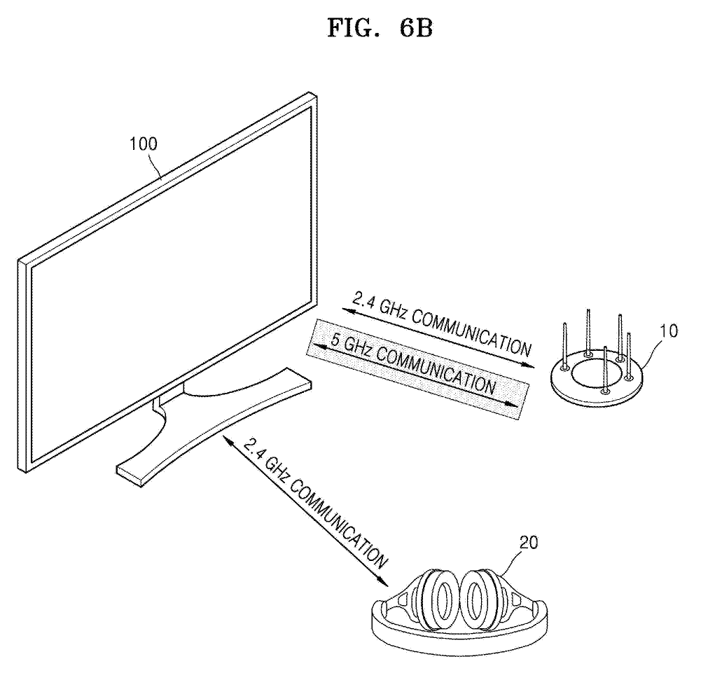

FIGS. 6A and 6B are reference diagrams for explaining frequency band reallocation between a plurality of wireless communication devices in an electronic device according to an embodiment.

Referring to FIG. 6A, the electronic device 100 senses communication connection with the Bluetooth headphone 20 while performing WiFi communication with the wireless router 10 by using a 2.4 GHz band. Because Bluetooth communication used by the Bluetooth headphone 20 uses a 2.4 GHz band, the electronic device 100 may determine that frequency bands used by the wireless router 10 and the Bluetooth headphone 20 may interfere with each other. The electronic device 100 may identify frequency bands usable by the wireless router 10, and may determine that the wireless router 10 may perform communication by using a 5 GHz frequency band.

Accordingly, referring to FIG. 6B, the electronic device 100 may allocate a 2.4 GHz frequency band already used by the wireless router 10 to communication with the Bluetooth headphone 20, and may allocate a 5 GHz frequency band instead of the 2.4 GHz frequency band to the wireless router 10.

According to an embodiment, the controller 180 may output a UI indicating that frequency interference occurred between a previously-connected wireless communication device and a new wireless communication device.

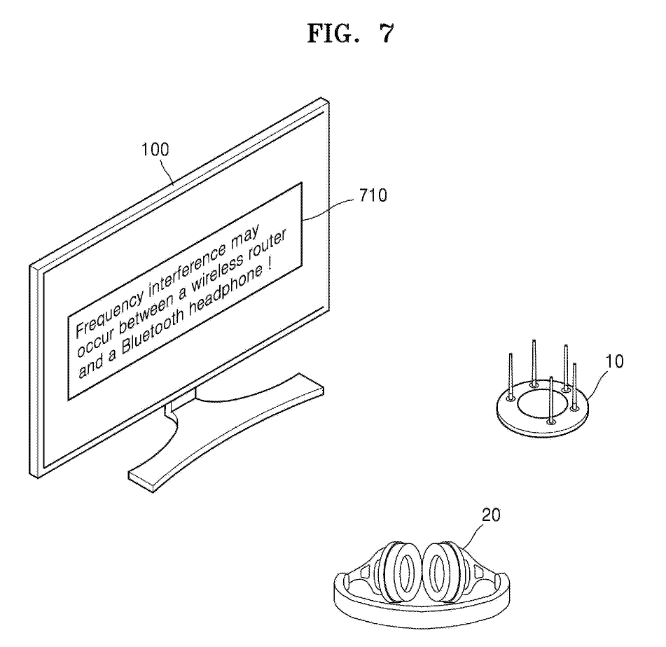

FIG. 7 illustrates an example of a UI that may be output during an operation of an electronic device according to an embodiment.

Referring to FIG. 7, when the electronic device 100 determines that frequency interference may occur between a frequency band used by the wireless router 10 and a frequency band used by the Bluetooth headphone 20, the electronic device 100 may output a message 710 <Frequency interference may occur between a wireless router and a Bluetooth headphone!>, which indicates that frequency interference may occur, to a display of the electronic device 100.

According to an embodiment, when frequency interference has occurred between a previously-connected wireless communication device and a new wireless communication device, the controller 180 may output a UI indicating that frequency reallocation is performed in order to avoid frequency interference.

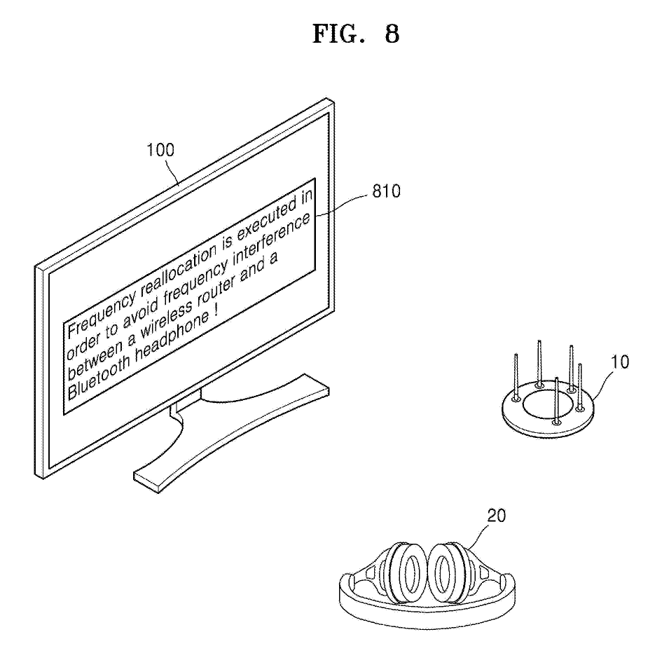

FIG. 8 illustrates another example of a UI that may be output during an operation of an electronic device according to an embodiment.

Referring to FIG. 8, when the electronic device 100 reallocates frequency bands to the wireless router 10 and the Bluetooth headphone 20 in order to avoid frequency interference between the frequency band used by the wireless router 10 and the frequency band used by the Bluetooth headphone 20, the electronic device 100 may output a message 810 <Frequency reallocation is executed in order to avoid frequency interference between a wireless router and a Bluetooth headphone!>, which indicates execution of frequency reallocation, to the display of the electronic device 100.

According to an embodiment, when the controller 180 determines that frequency interference occurs between a previously-connected wireless communication device and a new wireless communication device and accordingly frequency reallocation is attempted to avoid frequency inference, but allocation capable of avoiding frequency inference is difficult and disconnection may enable communication with one of the two devices, the controller 180 may output a UI indicating the meaning of this determination.

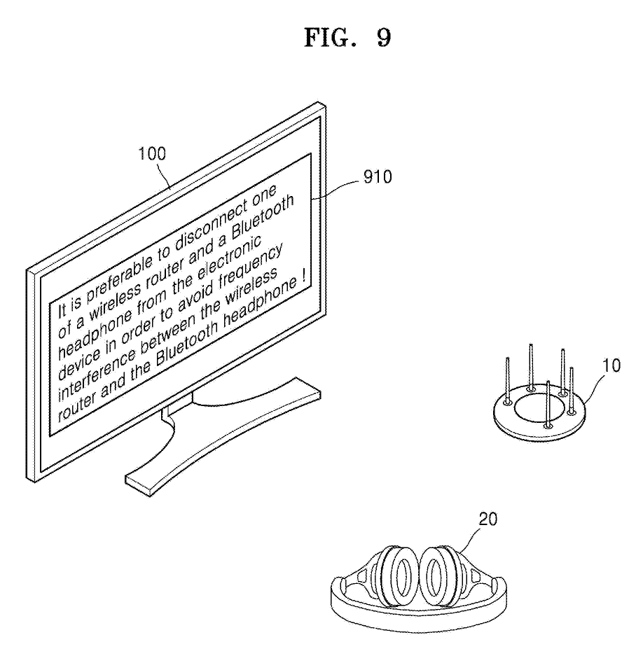

FIG. 9 illustrates another example of a UI that may be output during an operation of an electronic device according to an embodiment.

Referring to FIG. 9, when the electronic device 100 tries to reallocate frequency bands to the wireless router 10 and the Bluetooth headphone 20 in order to avoid frequency interference between the frequency band used by the wireless router 10 and the frequency band used by the Bluetooth headphone 20, but does not find frequency bands between which frequency interference may be avoided, the electronic device 100 may output a message 910 <It is preferable to disconnect one of a wireless router and a Bluetooth headphone from the electronic device in order to avoid frequency interference between the wireless router and the Bluetooth headphone!>, which recommends disconnection of one of the two devices from the electronic device 100, to the display of the electronic device 100.

According to an embodiment, when frequency interference has occurred between a previously-connected wireless communication device and a new wireless communication device, the controller 180 may output a UI indicating information about frequency bands usable by the previously-connected wireless communication device and information about frequency bands usable by the new wireless communication device.

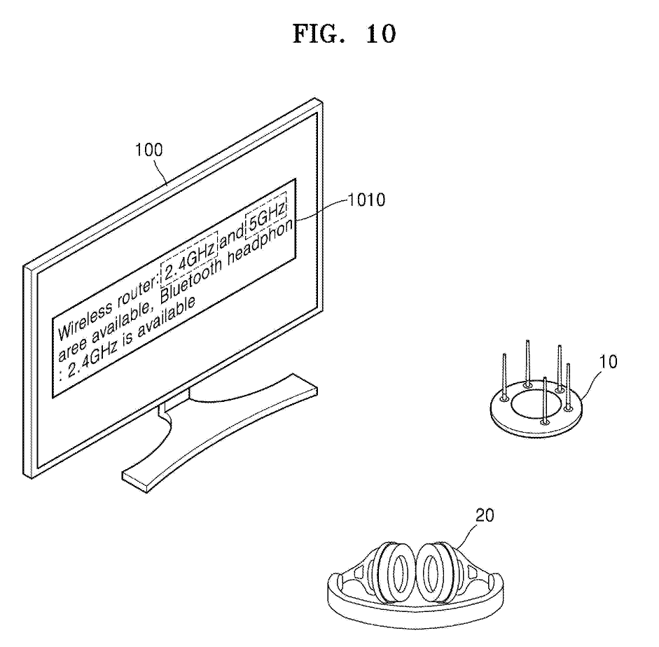

FIG. 10 illustrates another example of a UI that may be output during an operation of an electronic device according to an embodiment.

Referring to FIG. 10, when frequency interference has occurred between the frequency band used by the wireless router 10 and the frequency band used by the

Bluetooth headphone 20, the electronic device 100 may output a message 1010 <Wireless router: 2.4 GHz and 5 GHz are available, Bluetooth headphone: 2.4 GHz is available>to the display of the electronic device 100 in order to provide information about frequency bands that are usable by each of the two devices.

The electronic device 100 may receive a user input for selecting one of several frequency bands usable by a wireless communication device on the displayed message 1010. For example, in FIG. 10, because the wireless router may use 2.4 GHz and 5 GHz, the electronic device 100 may output a UI for enabling a user to select one from the two frequency bands of 2.4 GHz and 5 GHz, and may receive a user input from the UI.

A method of operating an electronic device according to an embodiment may be embodied as program commands executable by various computer means and may be recorded on a computer-readable recording medium. The computer-readable recording medium may include program commands, data files, data structures, and the like separately or in combinations. The program commands to be recorded on the computer-readable recording medium may be specially designed and configured for embodiments or may be well-known to and be usable by one of ordinary skill in the art of computer software. Examples of the computer-readable recording medium include a magnetic medium such as a hard disk, a floppy disk, or a magnetic tape, an optical medium such as a compact disk-read-only memory (CD-ROM) or a digital versatile disk (DVD), a magneto-optical medium such as a floptical disk, and a hardware device specially configured to store and execute program commands such as a ROM, a random-access memory (RAM), or a flash memory. Examples of the program commands are advanced language codes that can be executed by a computer by using an interpreter or the like as well as machine language codes made by a compiler.

While the present disclosure and advantages have been particularly shown and described with reference to embodiments thereof, it will be understood by those skilled in the art that various changes in form and details may be made therein without departing from the spirit and scope of the present disclosure as defined by the appended claims. The embodiments and the drawings should be considered in descriptive sense only and not for purposes of limitation. All differences within the scope will be construed as being included in the present disclosure.

1. An electronic device comprising:
a communicator;
a memory storing one or more instructions that are executed by a processor; and
a processor configured to execute the one or more instructions stored in the memory,
wherein the processor executes the one or more instructions to:
detect connection of a new wireless communication device;
obtain information about a frequency band which is used by the new wireless communication device; and
allocate, to the new wireless communication device and a previously-connected wireless communication device, respectively, frequency bands capable of not causing frequency interference therebetween in consideration of the information about the frequency band used by the new wireless communication device and information about a frequency band used by the previously-connected wireless communication device.

2. The electronic device of claim 1, wherein the processor executes the one or more instructions to, when it is determined that the frequency band used by the new wireless communication device interferes with the frequency band used by the previously-connected wireless communication device, allocate another frequency band as a frequency band for the previously-connected wireless communication device.

3. The electronic device of claim 1, wherein the processor executes the one or more instructions to, when it is determined that the frequency band used by the new wireless communication device interferes with the frequency band used by the previously-connected wireless communication device, output a user interface for indicating that the frequency band used by the new wireless communication device interferes with the frequency band used by the previously-connected wireless communication device.

4. The electronic device of claim 1, wherein the processor executes the one or more instructions to, when it is determined that the frequency band used by the new wireless communication device interferes with the frequency band used by the previously-connected wireless communication device, output a user interface for guiding at least one of the new wireless communication device and the previously-connected wireless communication device to be disconnected from the electronic device.

5. The electronic device of claim 1, wherein the processor executes the one or more instructions to receive, from the new wireless communication device, the information about the frequency band that is used by the new wireless communication device.

6. A method of operating an electronic device, the method comprising:
detecting connection of a new wireless communication device;
obtaining information about a frequency band that is used by the new wireless communication device; and
allocating, to the new wireless communication device and a previously-connected wireless communication device, respectively, frequency bands capable of not causing frequency interference therebetween in consideration of the information about the frequency band used by the new wireless communication device and information about a frequency band used by the previously-connected wireless communication device.

7. The method of claim 6, wherein the respective allocating comprises allocating another frequency band as a frequency band for the previously-connected wireless communication device.

8. The method of claim 6, wherein the respective allocating comprises, when it is determined that the frequency band used by the new wireless communication device interferes with the frequency band used by the previously-connected wireless communication device, outputting a user interface for indicating that the frequency band used by the new wireless communication device interferes with the frequency band used by the previously-connected wireless communication device.

9. The method of claim 6, wherein the respectively allocating comprises, when it is determined that the frequency band used by the new wireless communication device interferes with the frequency band used by the previously-connected wireless communication device, outputting a user interface for guiding at least one of the new wireless communication device and the previously-connected wireless communication device to be disconnected from the electronic device.

10. The method of claim 6, wherein the obtaining of the information about the frequency band that is used by the new wireless communication device comprises receiving, from the new wireless communication device, the information about the frequency band that is used by the new wireless communication device.
